(19) United States
(12) Patent Application Publication
(10) Pub. No.: US 2025/0001721 A1
(43) Pub. Date: Jan. 2, 2025

(54) THERMOPLASTIC BAGS WITH ENHANCED DART IMPACT RESISTANCE

(71) Applicant: The Glad Products Company, Oakland, CA (US)

(72) Inventors: Michael G. Borchardt, Naperville, IL (US); Anthony A. Cisek, Willowbrook, IL (US)

(21) Appl. No.: 18/883,883

(22) Filed: Sep. 12, 2024

Related U.S. Application Data
(63) Continuation-in-part of application No. 18/525,492, filed on Nov. 30, 2023.
Application No. 18/525,492 is a continuation of application No. 18/491,008, filed on Oct. 20, 2023.
Application No. 18/491,008 is a continuation of application No. 17/933,332, filed on Sep. 19, 2022, now Pat. No. 11,826,996.
Application No. 17/933,332 is a continuation of application No. 16/761,191, filed on May 1, 2020, now Pat. No. 11,485,108.
(60) Provisional application No. 62/583,108, filed on Nov. 8, 2017.

(51) Int. Cl. B32B 3/28; B29C 55/08; B29C 55/18; B29D 7/01; B31B 70/00; B31B 70/86; B31B 70/88; B31B 155/00; B31B 170/20; B32B 3/30; B32B 7/05; B32B 27/08; B32B 37/00; B65D 65/40; B65F 1/00

(52) U.S. Cl. CPC B32B 3/28; B29C 55/08; B29C 55/18; B29D 7/01; B31B 70/008; B31B 70/88; B32B 3/30; B32B 27/08; B65D 65/403; B65F 1/0006; B31B 70/866; B31B 2155/0014; B31B 2155/002; B31B 2170/20; B32B 7/05; B32B 37/0038; B32B 2274/00; B32B 2307/7145; B65F 2250/114

(57) ABSTRACT

The present disclosure relates to thermoplastic bags with enhanced dart impact resistance. In particular, in one or more embodiments, the disclosed thermoplastic bags include a first sidewall and a second sidewall joined together along a first side edge, a second side edge, and a bottom edge, while having an opening opposite the bottom edge. Furthermore, in some embodiments, the disclosed thermoplastic bags have a pattern of raised rib-like elements and web areas formed in the first sidewall. In one or more embodiments, the pattern of raised rib-like elements and web areas comprises a first motif of deformations that repeats in the pattern and a second motif of deformations interspersed with the first motif of deformations within the pattern. In one or more embodiments, the web areas lack sharp corners. The interspersed motifs and/or the lack of sharp corners can serve to increase dart impact resistance of the thermoplastic bags.

### CROSS-REFERENCE TO RELATED APPLICATIONS

The present application is a continuation-in-part of U.S. patent application Ser. No. 18/525,492 filed Nov. 30, 2023, which is a continuation application of U.S. patent application Ser. No. 18/491,008 filed Oct. 20, 2023, which is a continuation of U.S. patent application Ser. No. 17/933,332 filed on Sep. 19, 2022, which is a continuation of U.S. patent application Ser. No. 16/761,191 filed on May 1, 2020, which is a National Stage Entry of PCT/US2018/058998 filed on Nov. 2, 2018, which claims the benefit of and priority to U.S. Provisional Application No. 62/583,108, filed Nov. 8, 2017 and entitled: THERMOPLASTIC FILMS AND BAGS WITH COMPLEX STRETCH PATTERNS AND METHODS OF MAKING THE SAME. The contents of the above-referenced applications are hereby incorporated by reference in their entirety.

### BACKGROUND

Thermoplastic films are a common component in various commercial and consumer products. For example, grocery bags, trash bags, sacks, and packaging materials are products that are commonly made from thermoplastic films. Additionally, feminine hygiene products, baby diapers, adult incontinence products, and many other products include thermoplastic films to one extent or another.

The cost to produce products including thermoplastic film is directly related to the cost of the thermoplastic film. Recently the cost of thermoplastic materials has risen. In response, one or more attempt to control manufacturing costs by decreasing the amount of thermoplastic material in a product. One-way manufacturers may attempt to reduce production costs is to stretch the thermoplastic film, thereby increasing its surface area and reducing the amount of thermoplastic film needed to produce a product of a given size.

While thinner gauge materials can represent cost savings to the manufacturer, the use of thinner gauge films can result in lower durability. Although one or more recent technology may, in one or more cases at least, result in relatively thinner gauge films that may be as strong as their thicker counterparts, customers naturally sense from prior experience that thinner gauge materials are lower in quality and durability.

For example, one or more cues to a customer of lower quality and durability of a film are how thick or thin the film feels and how thin or weak the film “looks.” Customers tend to view thin looking or feeling films as having relatively low strength. Thus, even though one or more mechanisms can improve one or more aspects of film strength while using a thinner gauge, the look and feel of such films tend to cause customers to believe the film is nevertheless low quality. To provide additional strength and flexibility, one or more manufacturers seek to provide thermoplastic films with elastic-like behavior by adding elastic materials or using specialized processing of the films.

Accordingly, there are various considerations to be made with regard to thermoplastic films and products formed therefrom.

### BRIEF SUMMARY

Embodiments of the present disclosure provide benefits and/or solve one or more problems in the art with thermoplastic films and bags that have enhanced dart impact resistance over conventional films and bags. For example, in one or more embodiments, the disclosed thermoplastic bags include deformations arranged in patterns that provide increased strength to withstand impacts and reduce creation of holes and tears. In one or more embodiments, the pattern of raised rib-like elements and web areas comprises a first motif of deformations that repeats in the pattern and a second motif of deformations interspersed with the first motif of deformations within the pattern. In one or more embodiments, the web areas lack sharp corners. The interspersed motifs and/or the lack of sharp corners in the web areas serve to increase dart impact resistance of the thermoplastic bags.

For example, one or more implementations of the present disclosure includes a thermoplastic bag including a plurality of raised rib-like elements extending in a direction perpendicular to a main surface of the thermoplastic film or bag. The thermoplastic film or bag further includes a plurality of web areas positioned about the plurality of raised rib-like elements. The plurality of raised rib-like elements and the plurality of web areas are sized and positioned to create a pattern of raised rib-like elements comprising first and second motifs of raised rib-like elements that repeat within the pattern such that the second motifs of raised rib-like elements are interspersed with the first motif of raised rib-like elements within the pattern. The interspersed motifs serve to increase dart impact resistance of the thermoplastic bags.

One or more implementations of the present disclosure includes a thermoplastic bag including a plurality of raised rib-like elements and a plurality of web areas positioned about the plurality of raised rib-like elements. The plurality of raised rib-like elements and the plurality of web areas are sized and positioned such that the web areas lack sharp corners. The lack of sharp corners can reduce stress concentrations or weak points formed in the individual films during formation of the deformations, thereby increasing the strength of the thermoplastic bags by helping prevent holes and tears.

The following description sets forth additional features and advantages of one or more embodiments of the disclosed thermoplastic films and bags. In one or more cases, such features and advantages are evident to a skilled artisan having the benefit of this disclosure or may be learned by the practice of the disclosed embodiments.

### BRIEF DESCRIPTION OF THE DRAWINGS

In order to describe the manner in which the above recited and other advantages and features of the present disclosure can be obtained, a more particular description of the present disclosure briefly described above will be rendered by reference to specific implementations thereof which are illustrated in the appended drawings. It should be noted that the figures are not drawn to scale, and that elements of similar structure or function are generally represented by like reference numerals for illustrative purposes throughout the figures. Understanding that these drawings depict only typical implementations of the present disclosure and are not therefore to be considered to be limiting of its scope, the present disclosure will be described and explained with additional specificity and detail through the use of the accompanying drawings in which:

FIGS. 1A-1C show partial side cross-sectional views of thermoplastic films having varying numbers of sublayers according to one or more implementations of the present disclosure;

FIG. 2 shows a perspective view of a pair of SELF'ing rollers utilized to form deformation patterns in thermoplastic films according to one or more implementations of the present disclosure;

FIG. 3 shows a perspective view of a SELF'ed thermoplastic film having a pattern of deformations according to one or more implementations of the present disclosure;

FIG. 4 shows a perspective view of a multi-layer SELF'ed thermoplastic film having a pattern of deformations according to one or more implementations of the present disclosure;

FIG. 5 shows a partial perspective view of a thermoplastic film having a pattern of deformations according to one or more implementations of the present disclosure;

FIG. 6 shows a front view of a thermoplastic film having a pattern of deformations in the form of a checkerboard pattern according to one or more implementations of the present disclosure;

FIG. 7 shows a front view of a thermoplastic film having a pattern of deformations in the form of elongated bulbs with enclosed diamonds according to one or more implementations of the present disclosure;

FIG. 8 shows a front view of a thermoplastic film having a pattern of deformations in the form of elongated bulbs with enclosed diamonds, with web areas that lack sharp corners, according to one or more implementations of the present disclosure;

FIG. 9 shows a front view of a thermoplastic film with a pattern of deformations in the form of micro and macro diamond patterns according to one or more implementations of the present disclosure;

FIG. 10 shows a front view of a thermoplastic film with a pattern of deformations in the form of micro and macro diamond patterns, with web areas that lack sharp corners, according to one or more implementations of the present disclosure;

FIG. 11 shows a front view of a thermoplastic film with a pattern of deformations in the form of a first motif of diamond patterns and a second motif of diamond patterns, with web areas that lack sharp corners, according to one or more implementations of the present disclosure;

FIG. 12 shows a perspective view of a thermoplastic bag having a pattern of deformations according to one or more implementations of the present disclosure;

FIG. 13 is a front view of a thermoplastic bag with a pattern of deformations in the form of elongated bulbs with enclosed diamonds according to an implementation of the present disclosure;

FIG. 14A is a front view of a thermoplastic bag with a pattern of deformations in the form of elongated bulbs with enclosed diamonds, with web areas that lack sharp corners, according to an implementation of the present disclosure;

FIG. 14B is a front view of a thermoplastic bag with a pattern of deformations in the form of elongated bulbs, with web areas that lack sharp corners, according to an implementation of the present disclosure;

FIG. 15 is a front view of a thermoplastic bag with a pattern of deformations in the form of hexagons and elongated diamonds according to an implementation of the present disclosure;

FIG. 16 is a front view of another thermoplastic bag with a pattern of deformations in the form of hexagons and diamonds according to an implementation of the present disclosure;

FIG. 17 is a front view of a thermoplastic bag with a pattern of deformations in a band across the width of the bag but only a portion of the height of the bag according to an implementation of the present disclosure;

FIG. 18 is a front view of another thermoplastic bag with a pattern of deformations in a band across the width of the bag but only a portion of the height of the bag according to an implementation of the present disclosure;

FIG. 19 illustrates a schematic diagram of a process for manufacturing thermoplastic bags in accordance with one or more implementations of the present disclosure; and

FIG. 20 illustrates a schematic diagram of a process for manufacturing multilayered thermoplastic bags in accordance with one or more implementations of the present disclosure.

### DETAILED DESCRIPTION

One or more implementations of the present disclosure include thermoplastic films and bags with patterns of structural elastic-like film (SELF'ing) deformations. As described below, the patterns of SELF'ing deformations provide thermoplastic films—and products made therefrom—with various advantages. For example, the disclosed patterns of SELF'ing deformations can provide enhanced dart impact resistance over existing thermoplastic films.

Various implementations include thermoplastic films with strainable networks created by a SELF'ing process. The strainable network can comprise a plurality of raised rib-like elements extending in a direction perpendicular to a main surface of the thermoplastic film. In one or more embodiments, the raised rib-like elements are surrounded by a plurality of web areas. The raised rib-like elements and web areas can comprise a strainable network that provides the thermoplastic film with an elastic-like behavior. In particular, when subjected to an applied load, the raised rib-like elements can initially undergo a substantially geometric deformation before undergoing substantial molecular-level deformation when subjected to an applied load. On the other hand, the web areas can undergo a substantially molecular-level and geometric deformation in response to the applied strain. U.S. Pat. Nos. 5,518,801 and 5,650,214 each disclose processes for forming strainable networks using SELF'ing processes. The contents of each of the aforementioned patents are incorporated in their entirety by reference herein.

In addition to the elastic-like characteristics mentioned above and the other benefits described in the above incorporated patents, implementations of the present disclosure include sized, shaped, and positioned strainable networks in patterns that provide previously unrealized film properties and characteristics. For example, one or more implementations include shaping, sizing, and positioning the plurality of raised rib-like elements and the plurality of web areas such that, when subjected to an impact (e.g., by a sharp object), the thermoplastic film has an increased tendency to withstand the impact and a reduced tendency to puncture.

For instance, in one or more embodiments of the present disclosure, a thermoplastic film includes a strainable network in a pattern of raised rib-like elements and web areas with a first motif of deformations and a second motif of deformations. More particularly, in one or more embodiments, the first motif of deformations repeats in the pattern, and the second motif of deformations is interspersed with the first motif of deformations within the pattern. As described in additional detail below, in one or more embodiments, the first motif includes a macro pattern of deformations and the second motif includes a micro pattern of deformations (or vice versa). Alternatively, in one or more embodiments, the first motif and the second motif both include a macro pattern of deformations (e.g., deformations of comparable size).

Moreover, in one or more implementations of the present disclosure, a thermoplastic film includes a strainable network of deformations in a pattern of raised rib-like elements and web areas separating repeat units of the raised rib-like elements. More particularly, in one or more embodiments, the web areas lack sharp corners. For example, the web areas lack corners, or the corners of the web areas are rounded. In one or more implementations, the absence of sharp corners in the web areas helps reduce or mitigate potential stress concentrations in the thermoplastic film, thereby improving the thermoplastic film's dart impact resistance.

One or more implementations of the present disclosure include products made from or with such thermoplastic films with SELF'ing patterns. For example, such products include, but are not limited to, grocery bags, trash bags, sacks, packaging materials, feminine hygiene products, baby diapers, adult incontinence products, or other products. For ease in description, the figures and bulk of the following disclosure focuses on films and bags. One will appreciate that the teachings and disclosure herein equally applies to other products.

### Film Materials

As an initial matter, the thermoplastic material of the films of one or more implementations of the present disclosure may include thermoplastic polyolefins, including polyethylene and copolymers thereof and polypropylene and copolymers thereof. The olefin-based polymers may include ethylene or propylene based polymers such as polyethylene, polypropylene, and copolymers such as ethylene vinyl acetate (EVA), ethylene methyl acrylate (EMA) and ethylene acrylic acid (EAA), or blends of such polyolefins.

Other examples of polymers suitable for use as films in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

One or more of the examples and description herein below refer to films formed from linear low-density polyethylene. The term “linear low density polyethylene” (LLDPE) as used herein is defined to mean a copolymer of ethylene and a minor amount of an olefin containing 4 to 10 carbon atoms, having a density of from about 0.910 to about 0.930, and a melt index (MI) of from about 0.5 to about 10. For example, one or more examples herein use an octene comonomer, solution phase LLDPE (MI=1.1; ρ=0.920). Additionally, other examples use a gas phase LLDPE, which is a hexene gas phase LLDPE formulated with slip/AB (MI=1.0; ρ=0.920). Still further examples use a gas phase LLDPE, which is a hexene gas phase LLDPE formulated with slip/AB (MI=1.0; ρ=0.926). One will appreciate that the present disclosure is not limited to LLDPE, and can include “high density polyethylene” (HDPE), “low density polyethylene” (LDPE), and “very low density polyethylene” (VLDPE). Indeed, films made from any of the previously mentioned thermoplastic materials or combinations thereof can be suitable for use with the present disclosure.

One or more implementations of the present disclosure may include any flexible or pliable thermoplastic material that may be formed or drawn into a web or film. Furthermore, the thermoplastic materials may include a single layer or multiple layers. The thermoplastic material may be opaque, transparent, translucent, or tinted. Furthermore, the thermoplastic material may be gas permeable or impermeable.

As used herein, the term “flexible” refers to materials that are capable of being flexed or bent, especially repeatedly, such that they are pliant and yieldable in response to externally applied forces. Accordingly, “flexible” is substantially opposite in meaning to the terms inflexible, rigid, or unyielding. Materials and structures that are flexible, therefore, may be altered in shape and structure to accommodate external forces and to conform to the shape of objects brought into contact with them without losing their integrity. In accordance with further prior art materials, web materials are provided which exhibit an “elastic-like” behavior in the direction of applied strain without the use of added traditional elastic materials. As used herein, the term “elastic-like” describes the behavior of web materials which when subjected to an applied strain, the web materials extend in the direction of applied strain, and when the applied strain is released the web materials return, to a degree, to their pre-strained condition.

As used herein, the term “substantially,” in reference to a given parameter, property, or condition, means to a degree that one of ordinary skill in the art would understand that the given parameter, property, or condition is met within a degree of variance, such as within acceptable manufacturing tolerances. By way of example, depending on the particular parameter, property, or condition that is substantially met, the parameter, property, or condition may be at least 70.0% met, at least 80.0%, at least 90% met, at least 95.0% met, at least 99.0% met, or even at least 99.9% met.

Additional additives that may be included in one or more implementations include slip agents, anti-block agents, voiding agents, or tackifiers. Additionally, one or more implementations of the present disclosure include films that are devoid of voiding agents. One or more examples of inorganic voiding agents, which may further provide odor control, include the following but are not limited to: calcium carbonate, magnesium carbonate, barium carbonate, calcium sulfate, magnesium sulfate, barium sulfate, calcium oxide, magnesium oxide, titanium oxide, zinc oxide, aluminum hydroxide, magnesium hydroxide, talc, clay, silica, alumina, mica, glass powder, starch, charcoal, zeolites, any combination thereof, etc. Organic voiding agents, polymers that are immiscible in the major polymer matrix, can also be used. For instance, polystyrene can be used as a voiding agent in polyethylene and polypropylene films.

One of ordinary skill in the art will appreciate in view of the present disclosure that manufacturers may form the films or webs to be used with the present disclosure using a wide variety of techniques. For example, a manufacturer can form precursor mix of the thermoplastic material and one or more additives. The manufacturer can then form the film(s) from the precursor mix using conventional flat or cast extrusion or co-extrusion to produce monolayer, bilayer, or multilayer films. Alternatively, a manufacturer can form the films using suitable processes, such as, a blown film process to produce monolayer, bilayer, or multilayer films. If desired for a given end use, the manufacturer can orient the films by trapped bubble, tenterframe, or other suitable process. Additionally, the manufacturer can optionally anneal the films thereafter.

An optional part of the film-making process is a procedure known as “orientation.” The orientation of a polymer is a reference to its molecular organization, i.e., the orientation of molecules relative to each other. Similarly, the process of orientation is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process can require different procedures. This is related to the different physical characteristics possessed by films made by conventional film-making processes (e.g., casting and blowing). Generally, blown films tend to have greater stiffness and toughness. By contrast, cast films usually have the advantages of greater film clarity and uniformity of thickness and flatness, generally permitting use of a wider range of polymers and producing a higher quality film.

When a film has been stretched in a single direction (mono-axial orientation), the resulting film can exhibit strength and stiffness along the direction of stretch, but can be weak in the other direction, i.e., across the stretch, often splitting when flexed or pulled. To overcome this limitation, two-way or biaxial orientation can be employed to more evenly distribute the strength qualities of the film in two directions. Most biaxial orientation processes use apparatus that stretches the film sequentially, first in one direction and then in the other.

In one or more implementations, the films of the present disclosure are blown film, or cast film. Both a blown film and a cast film can be formed by extrusion. The extruder used can be a conventional one using a die, which will provide the desired gauge. One or more useful extruders are described in U.S. Pat. Nos. 4,814,135; 4,857,600; 5,076,988; 5,153,382; each of which are incorporated herein by reference in their entirety. Examples of various extruders, which can be used in producing the films to be used with the present disclosure, can be a single screw type modified with a blown film die, an air ring, and continuous take off equipment.

In one or more implementations, a manufacturer can use multiple extruders to supply different melt streams, which a feed block can order into different channels of a multi-channel die. The multiple extruders can allow a manufacturer to form a film with layers having different compositions. Such multi-layer film may later be provided with a pattern of deformations to provide the benefits of the present disclosure.

In a blown film process, the die can be an upright cylinder with a circular opening. Rollers can pull molten thermoplastic material upward away from the die. An air-ring can cool the film as the film travels upwards. An air outlet can force compressed air into the center of the extruded circular profile, creating a bubble. The air can expand the extruded circular cross section by a multiple of the die diameter. This ratio is called the “blow-up ratio.” When using a blown film process, the manufacturer can collapse the film to double the plies of the film. Alternatively, the manufacturer can cut and fold the film, or cut and leave the film unfolded.

In any event, in one or more implementations, the extrusion process can orient the polymer chains of the blown film. The “orientation” of a polymer is a reference to its molecular organization, i.e., the orientation of molecules or polymer chains relative to each other. In particular, the extrusion process can cause the polymer chains of the blown film to be predominantly oriented in the machine direction. The orientation of the polymer chains can result in an increased strength in the direction of the orientation. As used herein predominately oriented in a particular direction means that the polymer chains are more oriented in the particular direction than another direction. One will appreciate, however, that a film that is predominately oriented in a particular direction can still include polymer chains oriented in directions other than the particular direction. Thus, in one or more implementations the initial or starting films (films before being stretched or bonded or laminated in accordance with the principles described herein) can comprise a blown film that is predominately oriented in the machine direction.

The process of blowing up the tubular stock or bubble can further orient the polymer chains of the blown film. In particular, the blow-up process can cause the polymer chains of the blown film to be bi-axially oriented. Despite being bi-axially oriented, in one or more implementations the polymer chains of the blown film are predominantly oriented in the machine direction (i.e., oriented more in the machine direction than the transverse direction).

The films of one or more implementations of the present disclosure can have a starting gauge between about 0.1 mils to about 20 mils, suitably from about 0.2 mils to about 4 mils, suitably in the range of about 0.3 mils to about 2 mils, suitably from about 0.6 mils to about 1.25 mils, suitably from about 0.9 mils to about 1.1 mils, suitably from about 0.3 mils to about 0.7 mils, and suitably from about 0.3 mils and about 0.6 mils. Additionally, the starting gauge of films of one or more implementations of the present disclosure may not be uniform. Thus, the starting gauge of films of one or more implementations of the present disclosure may vary along the length and/or width of the film.

One or more layers of the films described herein can comprise any flexible or pliable material comprising a thermoplastic material and that can be formed or drawn into a web or film. As described above, the film includes a plurality of layers of thermoplastic films. Each individual film layer may itself include a single layer or multiple layers. In other words, the individual layers of the multi-layer film may each themselves comprise a plurality of laminated layers. Such layers may be significantly more tightly bonded together than the bonding provided by the purposely weak discontinuous bonding in the finished multi-layer film. Both tight and relatively weak lamination can be accomplished by joining layers by mechanical pressure, joining layers with adhesives, joining with heat and pressure, spread coating, extrusion coating, ultrasonic bonding, static bonding, cohesive bonding and combinations thereof. Adjacent sub-layers of an individual layer may be coextruded. Co-extrusion results in tight bonding so that the bond strength is greater than the tear resistance of the resulting laminate (i.e., rather than allowing adjacent layers to be peeled apart through breakage of the lamination bonds, the film will tear).

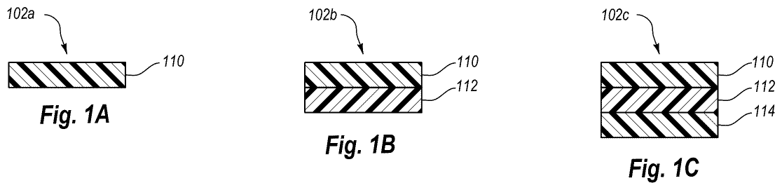

Films having enhanced dart impact resistance can include a single film formed from one, two, three, or more layers of thermoplastic material. FIGS. 1A-1C are partial cross-sectional views of films that can be included in a thermoplastic bag of one or more implementations. In one or more implementations, the film may include a single layer film 102a, as shown in FIG. 1A, comprising a single first layer 110. In other embodiments, the film can comprise a two-layer film 102b as shown in FIG. 1B, including a first layer 110 and a second layer 112. The first and second layers 110, 112 can be coextruded. In such implementations, the first and second layers 110, 112 may optionally include different grades of thermoplastic material and/or include different additives, including polymer additives. In yet other implementations, a film be a tri-layer film 102c, as shown in FIG. 1C, including a first layer 110, a second layer 112, and a third layer 114. In yet other implementations, a film may include more than three layers. The tri-layer film 102c can include an A:B:C configuration in which all three layers vary in one or more of gauge, composition, color, transparency, or other properties. Alternatively, the tri-layer film 102c can comprise an A:A:B structure or A:B:A structure in which two layers have the same composition, color, transparency, or other properties. In an A:A:B structure or A:B:A structure the A layers can comprise the same gauge or differing gauge. For example, in an A:A:B structure or A:B:A structure the film layers can comprise layer ratios of 20:20:60, 40:40:20, 15:70:15, 33:34:33, 20:60:20, 40:20:40, or other ratios.

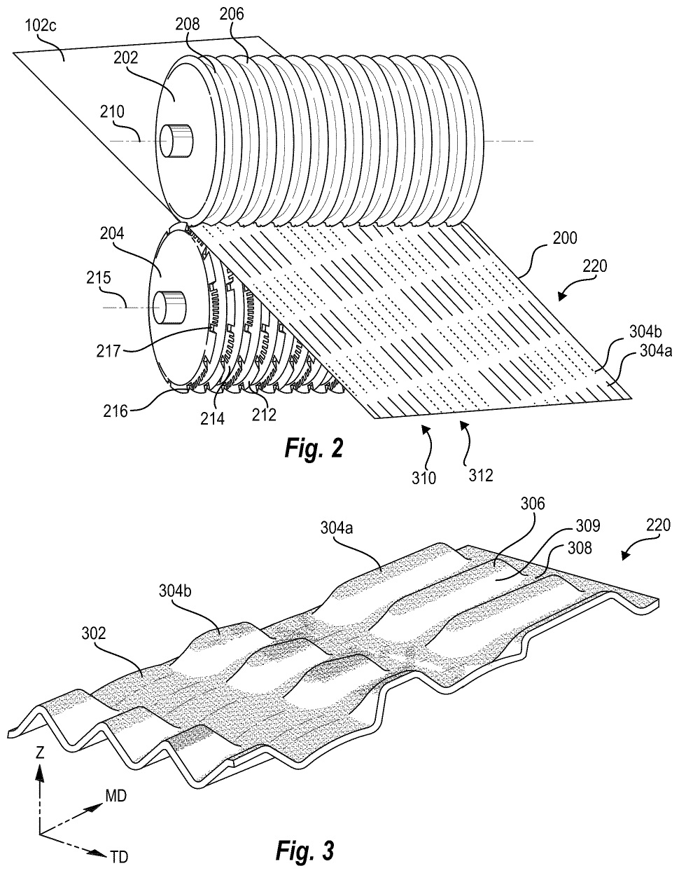

FIG. 2 shows a pair of SELF'ing intermeshing rollers 202, 204 (e.g., a first SELF'ing intermeshing roller 202 and a second SELF'ing intermeshing roller 204) for creating strainable networks with patterns of deformations. As shown in FIG. 2, the first SELF'ing intermeshing roller 202 may include a plurality of ridges 206 and grooves 208 extending generally radially outward in a direction orthogonal to an axis of rotation 210. As a result, the first SELF'ing intermeshing roller 202 can be similar to a transverse direction (“TD”) intermeshing roller such as the TD intermeshing rollers described in U.S. Pat. No. 9,186,862 to Broering et al., the disclosure of which is incorporated in its entirety by reference herein. The second SELF'ing intermeshing roller 204 can also include a plurality of ridges 212 and grooves 214 extending generally radially outward in a direction orthogonal to an axis of rotation 215. As shown in FIG. 2, in one or more embodiments, the ridges 212 of the second SELF'ing intermeshing roller 204 may include a plurality of notches 217 that define a plurality of spaced teeth 216.

As shown by FIG. 2, passing a film, such as film 102c, through the SELF'ing intermeshing rollers 202, 204 can produce a thermoplastic film 200 with one or more strainable networks formed by a structural elastic like process in which the strainable networks have a pattern 220 (e.g., in the form of a checkerboard pattern). As used herein, the term “strainable network” refers to an interconnected and interrelated group of regions which are able to be extended to one or more useful degree in a predetermined direction providing the web material with an elastic-like behavior in response to an applied and subsequently released elongation.

FIG. 3 shows a portion of the thermoplastic film 200 with the pattern 220. Referring to FIGS. 2 and 3 together, as film (e.g., multi-layer film 102c) passes through the SELF'ing intermeshing rollers 202, 204, the teeth 216 can press a portion of the film out of plane defined by the film to cause permanent deformation of a portion of the film in the Z-direction. For example, the teeth 216 can intermittently stretch a portion of the film 102c in the Z-direction. The portions of the film 102c that pass between the notched regions 217 of the teeth 216 will remain substantially unformed in the Z-direction. As a result of the foregoing, the thermoplastic film 200 with the pattern 220 includes a plurality of isolated deformed, raised, rib-like elements 304a/304b and at least one un-deformed portion (or web area) 302 (e.g., a relatively flat region). As will be understood by one of ordinary skill in the art, the length and width of the rib-like elements 304a/304b depend on the length and width of teeth 216 and the speed and the depth of engagement of the intermeshing rollers 202, 204. The rib-like elements 304a/304b and the un-deformed web areas 302 form a strainable network.

As shown in FIG. 3, the strainable network of the film 200 can include first thicker regions 306, second thicker regions 308, and stretched, thinner transitional regions 309 connecting the first and second thicker regions 306, 308. The thicker regions 306, 308 are thicker regions in that they are thicker than the thinner regions 310. Similarly, the thinner regions 310 are thinner regions in that they are thinner than the thicker regions 306, 308. The first thicker regions 306 and the stretched, thinner regions 309 can form the raised rib-like elements 304a/304b of the strainable network. In one or more embodiments, the first thicker regions 306 are the portions of the film with the greatest displacement in the Z-direction. In one or more embodiments, because the film is displaced in the Z-direction by pushing the rib-like elements 304a/304b in a direction perpendicular to a main surface of the thermoplastic film (thereby stretching the regions 309 upward) a total length and width of the film does not substantially change when the film is subjected to the SELF'ing process of one or more embodiments of the present invention. In other words, the film 102c (film prior to undergoing the SELF'ing process) can have substantially the same width and length as the film 200 resulting from the SELF'ing process.

As shown by FIG. 3, the rib-like elements can have a major axis and a minor axis (i.e., the rib-like elements are elongated such that they are longer than they are wide). As shown by FIGS. 2 and 3, in one or more embodiments, the major axes of the rib-like elements are parallel to the machine direction (i.e., the direction in which the film was extruded). In alternative embodiments, the major axes of the rib-like elements are parallel to the transverse direction. In still further embodiments, the major axes of the rib-like elements are oriented at an angle between 1 and 89 degrees relative to the machine direction. For example, in one or more embodiments, the major axes of the rib-like elements are at a 45-degree angle to the machine direction. In one or more embodiments, the major axes are linear (i.e., in a straight line). In alternative embodiments, the major axes are curved or have otherwise non-linear shapes.

The rib-like elements 304a/304b can undergo a substantially “geometric deformation” prior to a “molecular-level deformation.” As used herein, the term “molecular-level deformation” refers to deformation that occurs on a molecular level and is not discernible to the normal naked eye. That is, even though one may be able to discern the effect of molecular-level deformation, e.g., elongation or tearing of the film, one is not able to discern the deformation, which allows or causes it to happen. This is in contrast to the term “geometric deformation,” which refers to deformations that are generally discernible to the normal naked eye when a SELF'ed film or articles embodying such a film are subjected to an applied load or force. Types of geometric deformation include, but are not limited to bending, unfolding, and rotating.

Thus, upon application of a force, the rib-like elements 304a/304b can undergo geometric deformation before undergoing molecular-level deformation. For example, a strain applied to the film 200 in a perpendicular direction to the major axes of the rib-like elements 304a/304b can pull the rib-like elements 304a/304b back into plane with the web areas 302 prior to any molecular-level deformation of the rib-like elements 304a/304b. Geometric deformation can result in significantly less resistive forces to an applied strain than that exhibited by molecular-level deformation.

As mentioned above, the rib-like elements 304a/304b and the web areas 302 can be sized and positioned so as to create the pattern 220. The pattern can provide one or more of the benefits discussed herein. For example, the pattern can provide a thermoplastic film or multi-layer film structure (e.g., a sidewall of a thermoplastic bag) with increased impact resistance. Specifically, as mentioned previously, a pattern of multiple motifs (e.g., two motifs, three motifs, four motifs). The different motifs interspersed within the pattern of raised-rib like elements spread out and vary the location of stress concentrations, thereby, varying and reducing stress concentrations or weak points formed in the individual films during formation of the deformations, thereby, increasing the strength of the thermoplastic bags by helping prevent holes and tears. Alternatively, or additionally, the plurality of raised rib-like elements and the plurality of web areas are sized and positioned such that the web areas lack sharp corners. The lack of sharp corners reduce stress concentrations or weak points formed in the individual films during formation of the deformations, thereby increasing the strength of the thermoplastic bags by helping prevent holes and tears.

As shown by FIGS. 2 and 3, groups of rib-like elements 304a/304b can be arranged in different arrangements to form patterns with multiple motifs. For example, a first plurality of raised rib-like elements 304a can be arranged in a first motif (e.g., first pattern 310) and a second plurality of raised rib-like elements 304b can be arranged in a second motif (e.g., second pattern 312). The first and the second patterns 310, 312 of raised rib-like elements 304a, 304b can repeat across the thermoplastic film 200. As shown by FIG. 2, the first and the second patterns 310, 312 of raised rib-like elements 304a, 304b can form a checkerboard pattern 220 (e.g., a first motif of macro patterns checkered with a second motif of micro patterns). As described in further detail below, additional patterns are contemplated by this disclosure.

As used herein, a web area includes a space between two raised rib-like elements aligned in a row. For example, a web area includes a gap in a SELF'ing pattern left by a notch in a SELF'ing intermeshing roller (e.g., a notch that separates teeth on a single ridge of the intermeshing roller). In the aggregate, web areas include space of undeformed thermoplastic material that separates ribs within a particular shape. Various shapes of raised rib-like elements can be achieved by designing notches in positions of the intermeshing roller that produce the shapes in the thermoplastic film.

As used herein, a motif includes a group of raised rib-like elements formed into a shape or a pattern of shapes. In some embodiments, a motif is completely surrounded by web areas. Alternatively, in some embodiments, a motif is partially surrounded by web areas (e.g., surrounded by web areas in the machine direction) and partially adjacent ribs of another motif (e.g., surrounded by rib-like elements in the transverse direction).

In one or more implementations, the first pattern 310 is visually distinct from the second pattern 312. As used herein, the term “visually distinct” refers to features of the web material which are readily discernible to the normal naked eye when the web material or objects embodying the web material are subjected to normal use.

In one or more embodiments, the first pattern 310 of raised rib-like elements 304a comprises a macro pattern while the second pattern 312 of raised rib-like elements 304b comprises a micro pattern. As used herein a macro pattern is a pattern that is larger in one or more ways than a micro pattern. For example, as shown by FIG. 2, the macro pattern 310 has larger/longer raised rib-like elements 304a than the raised rib-like elements 304b of the micro pattern 312. In alternative embodiments, the surface area of a given macro pattern 310 covers more surface area than a surface area covered by a given micro pattern 312. In still further embodiments, a macro pattern 310 can include larger/wider web portions between adjacent raised rib-like elements than web portions between adjacent raised rib-like elements of a micro pattern 312.

As mentioned above, the raised rib-like elements 304a are longer than the raised rib-like elements 304b. In one or more embodiments, the raised rib-like elements 304a have a length at least 1.5 times the length of the raised rib-like elements 304b. For example, the raised rib-like elements 304a can have a length between 1.5 and 20 times the length of the raised rib-like elements 304b. In particular, the raised rib-like elements 304a can have a length 2, 3, 4, 5, 6, 8, or 10 times the length of the raised rib-like elements 304b.

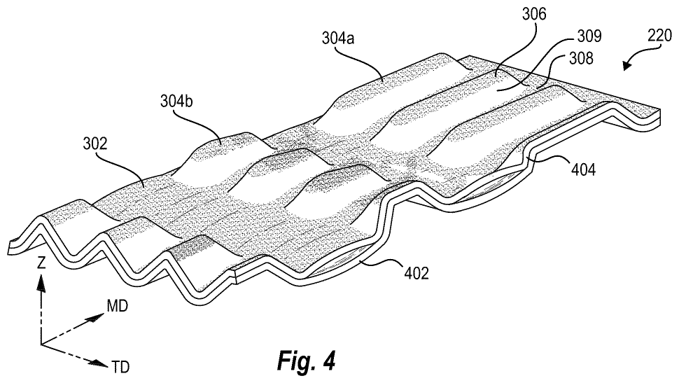

In one or more implementations, the films with patterns of deformations may comprise two or more distinct thermoplastic films (e.g., two films extruded separately). The distinct thermoplastic films can be non-continuously bonded to one another. For example, in one or more embodiments, two film layers can be passed together through a pair of SELF'ing rollers to produce a multi-layered lightly-bonded laminate film 200 with the pattern 220, as shown in FIG. 4. The multi-layered lightly-bonded laminate film 200 can comprise a first thermoplastic film 402 partially discontinuously bonded to a second thermoplastic film 404. In one or more embodiments, the bonds between the first thermoplastic film 402 and the second thermoplastic film 404 are aligned with the first thicker regions 306 and are formed by the pressure of the SELF'ing rollers displacing the raised rib-like elements 304a, 304b. Thus, the bonds can be parallel to the raised rib-like elements 304a, 304b and be positioned between raised rib-like elements 304a, 304b of the first thermoplastic film 402 and the second thermoplastic film 404.

As used herein, the terms “lamination,” “laminate,” and “laminated film,” refer to the process and resulting product made by bonding together two or more layers of film or other material. The term “bonding”, when used in reference to bonding of multiple layers of a multi-layer film, may be used interchangeably with “lamination” of the layers. According to methods of the present disclosure, adjacent layers of a multi-layer film are laminated or bonded to one another. The bonding purposely results in a relatively weak bond between the layers that has a bond strength that is less than the strength of the weakest layer of the film. This allows the lamination bonds to fail before the film layer, and thus the bond, fails.

The term laminate is also inclusive of co-extruded multilayer films comprising one or more tie layers. As a verb, “laminate” means to affix or adhere (by means of, for example, adhesive bonding, pressure bonding, ultrasonic bonding, corona lamination, static bonds, cohesive bonds, and the like) two or more separately made film articles to one another so as to form a multi-layer structure. As a noun, “laminate” means a product produced by the affixing or adhering just described.

As used herein the terms “partially discontinuous bonding” or “partially discontinuous lamination” refers to lamination of two or more layers where the lamination is substantially continuous in the machine direction or in the transverse direction, but not continuous in the other of the machine direction or the transverse direction. Alternately, partially discontinuous lamination refers to lamination of two or more layers where the lamination is substantially continuous in the width of the article but not continuous in the height of the article, or substantially continuous in the height of the article but not continuous in the width of the article. More particularly, partially discontinuous lamination refers to lamination of two or more layers with repeating bonded patterns broken up by repeating unbonded areas in either the machine direction or the transverse direction.

In one or more embodiments, the first and second films 402, 404 may be discontinuously bonded together via one or more of the methods of bonding films together as described in U.S. Pat. No. 8,603,609, the disclosure of which is incorporated in its entirety by reference herein. In particular, the first and second films 402, 404 may be bonded via one or more of MD rolling, TD rolling, DD ring rolling, SELF'ing, pressure bonding, corona lamination, adhesives, or combinations thereof. In one or more implementations, the first and second films 402, 404 may be bonded such that the bonded regions have bond strengths below a strength of the weakest film of the first and second films 402, 404. In other words, the bonded regions may fail (e.g., break apart) before the first or second films 402, 404 fail. As a result, discontinuously bonding the first and second films 402, 404 may also increase or otherwise modify one or more of the tensile strength, tear resistance, impact resistance (e.g., dart impact resistance), or elasticity of the films. Furthermore, the bonded regions between the first and second films 402, 404 may provide additional strength. Such bonded regions may be broken to absorb forces rather than such forces resulting in tearing of the film.

Furthermore, any of the pressure techniques (i.e., bonding techniques) described in U.S. Pat. No. 8,603,609 may be combined with other techniques in order to further increase the strength of the bonded regions while maintaining bond strength below the strength of the weakest layer of the multi-layer laminate film. For example, heat, pressure, ultrasonic bonding, corona treatment, or coating (e.g., printing) with adhesives may be employed. Treatment with a corona discharge can enhance any of the above methods by increasing the tackiness of the film surface so as to provide a stronger lamination bond, but which is still weaker than the tear resistance of the individual layers.

Discontinuously bonding the first and second films 402, 404 together results in un-bonded regions and bonded regions between the first and second films 402, 404. For example, discontinuously bonding the first and second films 402, 404 together may result in un-bonded regions and bonded regions as described in U.S. Pat. No. 9,637,278, the disclosure of which is incorporated in its entirety by reference herein.

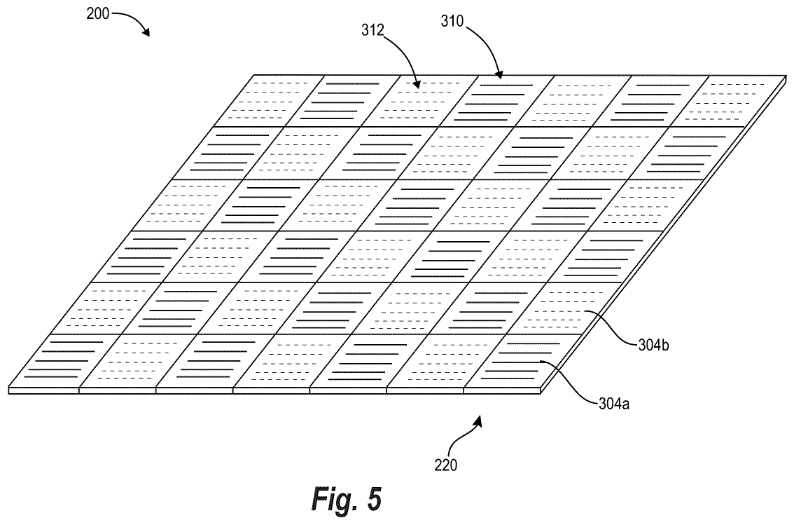

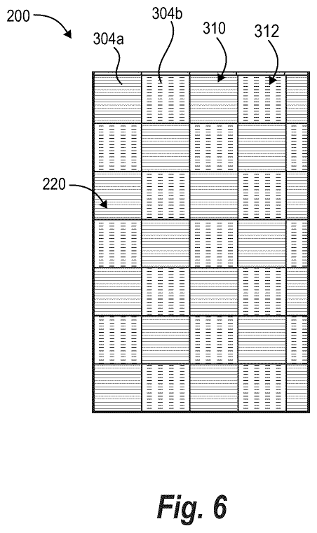

FIGS. 5 and 6 are, respectively, a perspective view and a top view of portions of a thermoplastic film 200 with a pattern 220 of raised rib-like elements and web areas formed in the thermoplastic film 200. In particular, the pattern 220 includes a first motif of raised rib-like elements 304a and a second motif of raised rib-like elements 304b. To illustrate, the first motif repeats in the pattern 220 (e.g., every other rectangle in a checkerboard layout) and the second motif is interspersed with the first motif within the pattern 220. As used herein, the term “interspersed” refers to an arrangement in a layout in which a first motif and a second motif are set among each other in a varied or alternating pattern within a region of a thermoplastic film.

As mentioned, in one or more cases, an interspersed pattern of multiple motifs of deformations (e.g., raised rib-like elements) helps to increase the dart impact resistance of a thermoplastic film or thermoplastic bag. For example, alternating or varying motifs in a pattern of deformations in the thermoplastic film can impart added strength to the thermoplastic film that helps to withstand impacts of objects (e.g., sharp objects) onto the thermoplastic film.

Moreover, in one or more embodiments, a first motif comprises a macro pattern of deformations and a second motif comprises a micro pattern of deformations. For instance, as illustrated by FIG. 5, the first motif of raised rib-like elements 304a includes the macro pattern 310 and the second motif of raised rib-like elements 304b includes the micro pattern 312. In this example, the macro pattern 310 has larger (e.g., longer) raised rib-like elements 304a than the raised rib-like elements 304b of the micro pattern 312.

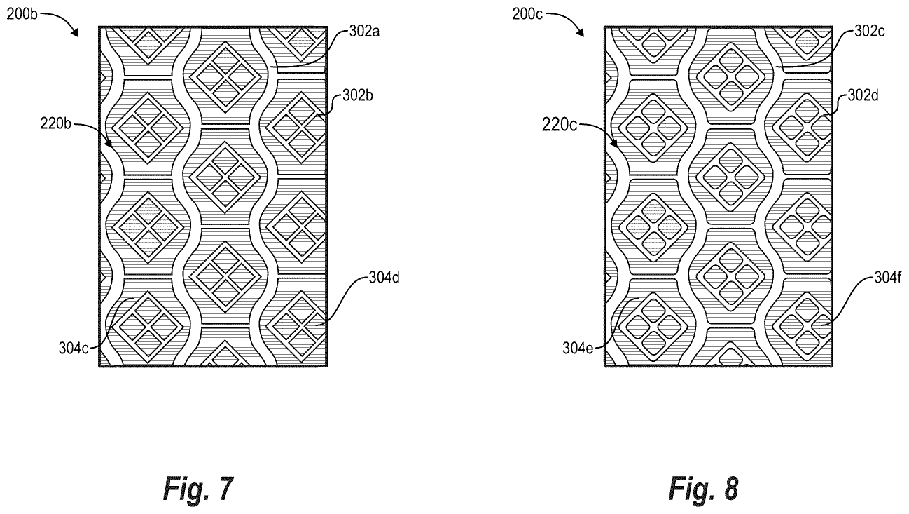

FIG. 7 is a top view of a thermoplastic film 200b having a pattern 220b according to another implementation of the present disclosure. The thermoplastic film 200b may include a first plurality of raised rib-like elements 304c in a first motif (e.g., a macro pattern, such as the bulbous pattern shown) and a second plurality of raised rib-like elements 304d in a second motif (e.g., a micro pattern, such as the diamond pattern shown). As shown, the second plurality of raised rib-like elements 304d in the second motif are interspersed with (e.g., nested within) the first motif. Furthermore, the thermoplastic film 200b includes web areas 302a, 302b. The web areas 302a, 302b can surround the first and second motifs of raised rib-like elements. Furthermore, as shown by FIG. 7, the web areas 302a are arranged in a sinusoidal pattern. The pattern of web areas 302a, 302b can affect the dart impact resistance of the thermoplastic film 200b. For instance, by interspersing the first motif with the second motif, the dart impact resistance of the thermoplastic film 200b can be enhanced.

FIG. 8 is a top view of a thermoplastic film 200c having a pattern 220c according to one or more implementations of the present disclosure. Similar to the thermoplastic film 200b, the thermoplastic film 200c may include a first plurality of raised rib-like elements 304e in a first motif (e.g., a macro pattern, such as the bulbous pattern shown) and a second plurality of raised rib-like elements 304f in a second motif (e.g., a micro pattern, such as the diamond pattern shown). As shown, the second plurality of raised rib-like elements 304f in the second motif are interspersed with (e.g., nested within) the first motif. Also similar to the thermoplastic film 200b, the thermoplastic film 200c may include web areas 302c, 302d. The web areas 302c, 302d can surround the first and second motifs of raised rib-like elements. In contrast with the thermoplastic film 200b, the web areas 302c, 302d of the thermoplastic film 200c lack sharp corners. As used herein, a sharp corner is a corner within a motif of raised rib-like elements that is not round. For example, a sharp corner includes a joint between two rectilinear lines defined by edges of ribs within the motif. For instance, a sharp corner is an angled transition between edges of a motif, as opposed to a smooth transition (e.g., a radiused transition) between edges of a motif. By contrast, a rounded corner is a corner of a motif that smoothly transitions from one edge of a motif to another edge of the motif.

For example, as shown in FIG. 8, the web areas 302d that surround the second plurality of raised rib-like elements 304f in the second motif have rounded corners. In one or more cases, by avoiding sharp corners in the web areas 302c, 302d, the thermoplastic film 200c can have an enhanced dart impact resistance (e.g., over the thermoplastic film 200b or over other thermoplastic films that have sharp corners in web areas).

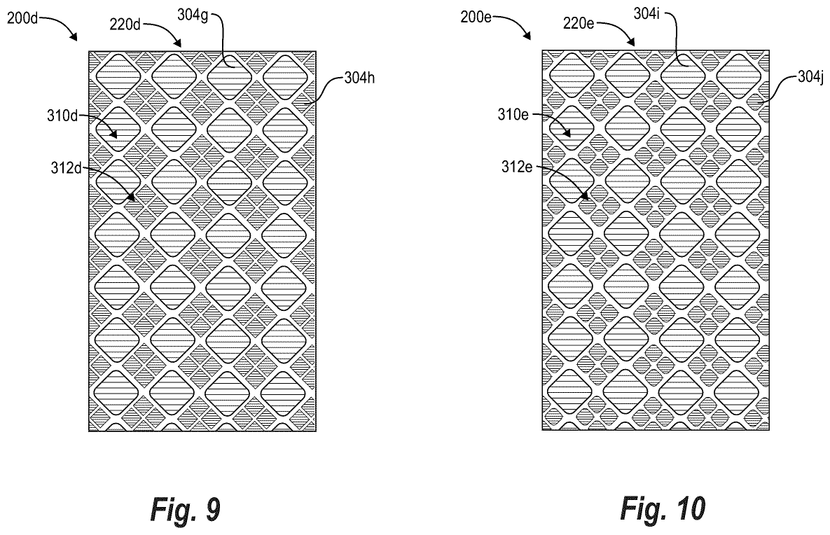

FIG. 9 is a top view of a thermoplastic film 200d having a pattern 220d according to another implementation of the present disclosure. The thermoplastic film 200d may include a first plurality of raised rib-like elements 304g in a first motif (e.g., a macro pattern, such as the diamond pattern 310d shown) and a second plurality of raised rib-like elements 304h in a second motif (e.g., a micro pattern, such as the four-square diamond pattern 312d shown). As shown, the second plurality of raised rib-like elements 304h in the second motif are interspersed with (e.g., surrounded by) the first motif. Furthermore, the thermoplastic film 200d includes web areas between the raised rib-like elements 304g, 304h. The web areas can surround the first and second motifs of raised rib-like elements. The pattern of first and second motifs can affect the dart impact resistance of the thermoplastic film 200d. For instance, by interspersing the first motif with the second motif, the dart impact resistance of the thermoplastic film 200d can be enhanced.

FIG. 10 is a top view of a thermoplastic film 200e having a pattern 220e according to one or more implementations of the present disclosure. Similar to the thermoplastic film 200d, the thermoplastic film 200e may include a first plurality of raised rib-like elements 304i in a first motif (e.g., a macro pattern, such as the diamond pattern 310e shown) and a second plurality of raised rib-like elements 304j in a second motif (e.g., a micro pattern, such as the four-square diamond pattern 312e shown). As shown, the second plurality of raised rib-like elements 304j in the second motif are interspersed with (e.g., surrounded by) the first motif. Also similar to the thermoplastic film 200d, the thermoplastic film 200e may include web areas between the raised rib-like elements 304i, 304j. The web areas can surround the first and second motifs of raised rib-like elements. In contrast with the thermoplastic film 200d, the web areas of the thermoplastic film 200e lack sharp corners. For example, as shown in FIG. 10, the web areas that surround the second plurality of raised rib-like elements 304j in the second motif have rounded corners. In one or more cases, by avoiding sharp corners in the web areas, the thermoplastic film 200e can have an enhanced dart impact resistance (e.g., over the thermoplastic film 200d or over other thermoplastic films that have sharp corners in web areas).

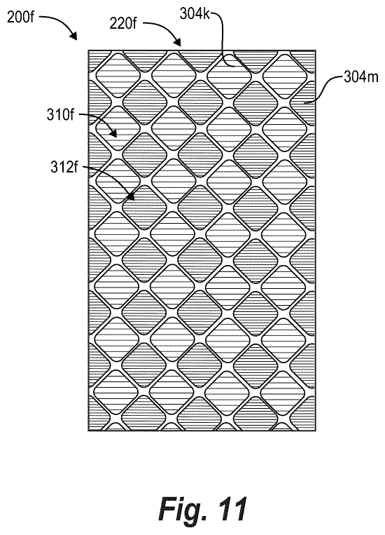

FIG. 11 is a top view of a thermoplastic film 200f having a pattern 220f according to one or more implementations of the present disclosure. Similar to the thermoplastic film 200e, the thermoplastic film 200f may include a first plurality of raised rib-like elements 304k in a first motif (e.g., the first diamond pattern 310f shown) and a second plurality of raised rib-like elements 304m in a second motif (e.g., the second diamond pattern 312f shown). As shown, the second plurality of raised rib-like elements 304m in the second motif are interspersed with (e.g., surrounded by) the first plurality of raised rib-like elements 304k in the first motif. Also similar to the thermoplastic film 200e, the thermoplastic film 200f includes web areas between the raised rib-like elements 304k, 304m. The web areas can surround the first and second motifs of raised rib-like elements.

Furthermore, and also similar to the thermoplastic film 200e, the web areas in the thermoplastic film 200f lack sharp corners. For example, each corner of the first diamond pattern 310f and the second diamond pattern 312f is rounded. In contrast with the thermoplastic film 200e, the first motif (of the first plurality of raised rib-like elements 304k) and the second motif (of the second plurality of raised rib-like elements 304m) are of comparable size. In particular, the first and second motifs in the thermoplastic film 200f do not comprise a macro pattern and a micro pattern, respectively, but rather comprise raised rib-like elements of the same size. In one or more cases, forming patterns of deformations that have a first motif interspersed with a second motif enhances the dart impact resistance of the thermoplastic film, even if the first motif and the second motif are similarly sized patterns. In other words, a macro pattern and a micro pattern of motifs is not necessary for enhancing dart strength of the thermoplastic film.

As shown by FIG. 11, however, the raised rib-like elements in the first motifs 310f are further spaced apart than the raised rib-like elements in the second motifs 312f. In other words, the raised rib-like elements in the second motifs 312f are more densely arranged than the raised rib-like elements in the first motifs 310f. For example, FIG. 11 shows that the raised rib-like elements in the second motifs 312f are twice as densely arranged as the raised rib-like elements in the first motifs 310f.

As mentioned above, one or more implementations of the present disclosure include products made from or with such thermoplastic films having the patterns described herein. For example, such products include, but are not limited to, grocery bags, trash bags, sacks, and packaging materials, feminine hygiene products, baby diapers, adult incontinence products, or other products. The following figures describe various bags including patterns that enhance dart impact resistance, and methods of making the same.

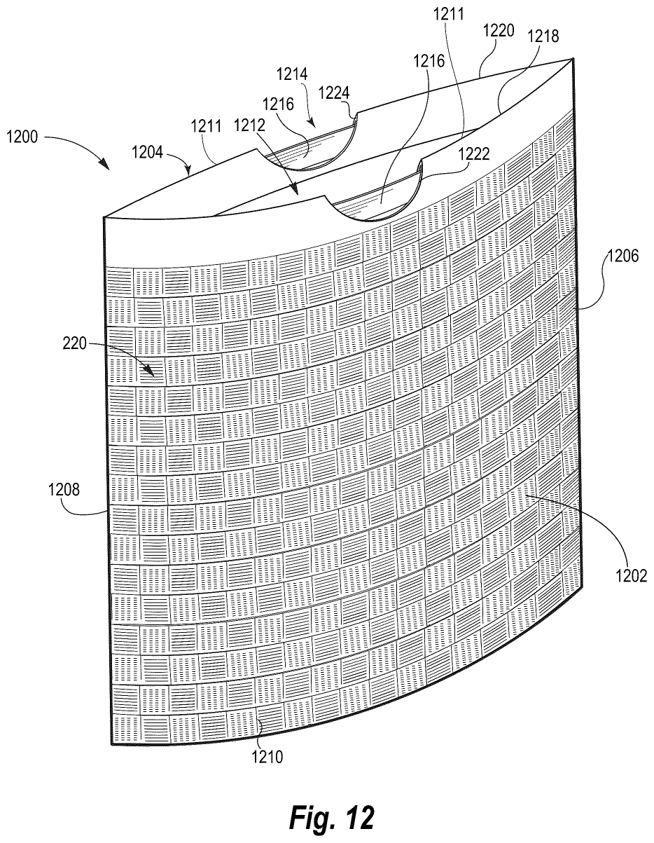

For example, FIG. 12 is a perspective view of a thermoplastic bag 1200 with a pattern 220 according to an implementation of the present disclosure. The thermoplastic bag 1200 with the pattern 220 includes a first sidewall 1202 and a second sidewall 1204. Each of the first and second sidewalls 1202, 1204 includes a first side edge 1206, a second opposite side edge 1208, a bottom edge 1210 extending between the first and second side edges 1206, 1208, and top edge 1211 extending between the first and second side edges 1206, 1208 opposite the bottom edge 1210. In one or more implementations, the first sidewall 1202 and the second sidewall 1204 are joined together along the first side edges 1206, the second opposite side edges 1208, and the bottom edges 1210. The first and second sidewalls 1202, 1204 may be joined along the first and second side edges 1206, 1208 and bottom edges 1210 by any suitable process such as, for example, a heat seal, or ultrasonic seals. In alternative implementations, the first and second sidewalls 1202, 1204 may not be joined along the side edges. Rather, the first and second sidewalls 1202, 1204 may be a single uniform piece. In other words, the first and second sidewalls 1202, 1204 may form a sleeve or a balloon structure.

In one or more implementations, the bottom edge 1210 or one or more of the side edges 1206, 1208 can comprise a fold. In other words, the first and second sidewalls 1202, 1204 may comprise a single unitary piece of material. The top edges 1211 of the first and second sidewalls 1202, 1204 may define an opening 1212 to an interior of the thermoplastic bag 1200. In other words, the opening 1212 may be oriented opposite the bottom edge 1210 of the thermoplastic bag 1200. Furthermore, when placed in a trash receptacle, the top edges 1211 of the first and second sidewalls 1202, 1204 may be folded over the rim of the receptacle.

In one or more implementations, the thermoplastic bag 1200 may optionally include a closure mechanism 1214 located adjacent to the top edges 1211 for sealing the top of the thermoplastic bag 1200 to form an at least substantially fully-enclosed container or vessel. As shown in FIG. 12, in one or more implementations, the closure mechanism 1214 comprises a draw tape 1216, a first hem 1218, and a second hem 1220. In particular, the first top edge 1211 of the first sidewall 1202 may be folded back into the interior volume and may be attached to an interior surface of the first sidewall 1202 to form the first hem 1218. Similarly, the second top edge 1211 of the second sidewall 1204 is folded back into the interior volume and may be attached to an interior surface of the second sidewall 1204 to form the second hem 1220. The draw tape 1216 extends through the first and second hems 1218, 1220 along the first and second top edges 1211. The first hem 1218 includes a first aperture 1222 (e.g., notch) extending through the first hem 1218 and exposing a portion of the draw tape 1216. Similarly, the second hem 1220 includes a second aperture 1224 extending through the second hem 1220 and exposing another portion of the draw tape 1216. During use, pulling the draw tape 1216 through the first and second apertures 1222, 1224 will cause the first and second top edge 1211 to constrict. As a result, pulling the draw tape 1216 through the first and second apertures 1222, 1224 will cause the opening 1212 of the thermoplastic bag to at least partially close or reduce in size. The closure mechanism 1214 may be used with any of the implementations of a thermoplastic bag described herein.

Although the thermoplastic bag 1200 is described herein as including a closure mechanism 1214 with a draw tape 1216, one of ordinary skill in the art will readily recognize that other closure mechanisms may be implemented into the thermoplastic bag 1200. For example, in one or more implementations, the closure mechanism 1214 may include one or more of flaps, adhesive tapes, a tuck and fold closure, an interlocking closure, a slider closure, a zipper closure, or any other closure structures known to those skilled in the art for closing a bag.

As shown in FIG. 12, the thermoplastic bag 1200 may include the pattern 220 formed in one or more of the first sidewall 1202 and the second sidewall 1204. For example, as discussed below, the pattern 220 may be formed in the first sidewall 1202 and/or the second sidewall 1204 via one or more of SELF'ing rollers or micro-SELF'ing rollers. As also discussed below, one or more embodiments of the present disclosure include similar thermoplastic bags with different patterns (e.g., one or more of the patterns 220b, 220c, 220d, 220e, or 220f described above). Specifically, the pattern includes multiple different motifs of raised rib-like elements that increase the impact resistance of the thermoplastic bag 1200.

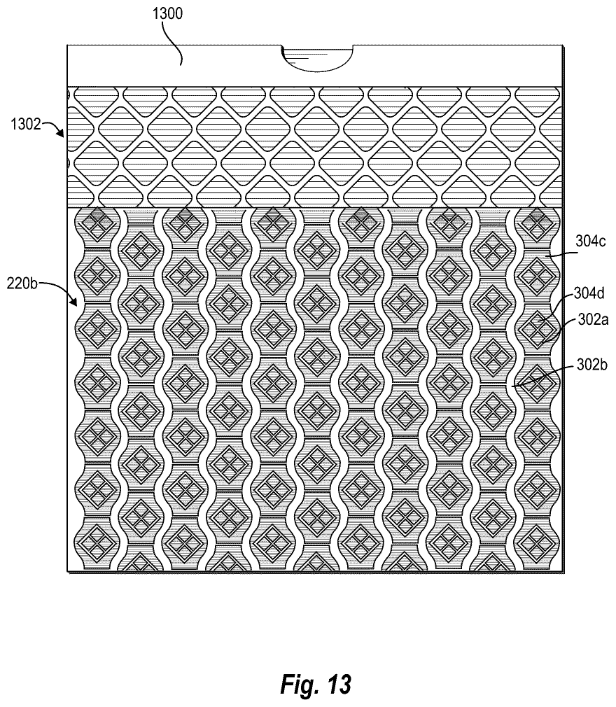

For example, FIG. 13 shows a thermoplastic bag 1300 with sidewalls including the pattern 220b formed therein. The thermoplastic bag 1300 can include the same structure as the thermoplastic bag 1200 albeit with a different pattern of deformations. In particular, the thermoplastic bag 1300 may include a first plurality of raised rib-like elements 304c in a first motif (e.g., a macro pattern, such as a bulbous pattern) and a second plurality of raised rib-like elements 304d in a second motif (e.g., a micro pattern, such as a four-square diamond pattern). As shown, the second plurality of raised rib-like elements 304d in the second motif are interspersed with (e.g., nested within) the first motif. Furthermore, the thermoplastic bag 1300 includes web areas 302a, 302b. The web areas 302a, 302b can surround the first and second motifs of raised rib-like elements.

Furthermore, as shown by FIG. 13, the web areas 302a are arranged in a sinusoidal pattern. The plurality of raised rib-like elements and the plurality of web areas of the pattern 220b can enhance the dart impact resistance of the thermoplastic bag 1300 (e.g., relative to a thermoplastic bag without the plurality of raised rib-like elements and the plurality of web areas of the pattern 220b). For example, the first plurality of raised rib-like elements 304c in the first motif and the second plurality of raised rib-like elements 304d in the second motif can provide added strength to the thermoplastic bag 1300 to better resist impacts of sharp objects.

Additionally, FIG. 13 illustrates that the thermoplastic bags described herein can include patterns (such as the pattern 220b) in certain areas or regions of the bag 1300 and other patterns in other areas or regions of the bag 1300. In particular, FIG. 13 illustrates that a top portion of the bag 1300 proximate the hem includes a fenced diamond pattern 1302. The fenced diamond pattern 1302 can comprise raised rib-like elements arranged in diamond patterns where the intersections of the sides of the diamond are rounded rather than ending in sharp corners.

In one or more embodiments, a thermoplastic bag has different areas or regions with different measures of dart impact resistance. For example, as shown, the thermoplastic bag 1300 has the pattern 220b in a first region and the pattern 1302 in a second region. In one or more cases, one region of the thermoplastic bag 1300 (e.g., the first region with the pattern 220b) has a higher dart impact resistance than another region of the thermoplastic bag 1300 (e.g., the second region with the pattern 1302).

Experiments of dart impact resistance were performed on thermoplastic films having the pattern 220b shown in FIG. 13. Five laminated multilayered films of 50% super hexene LLDPE having the pattern 220b (e.g., multi motifs and web areas lacking sharp edges) were measured to have an average dart impact resistance of 291 grams. In contrast, five laminated multilayered films of 50% super hexene LLDPE having a diamond pattern of raised rib-like elements (e.g., a single motif) with web areas with sharp edges had an average dart impact resistance of 168 grams. As discussed below, rounding the corners of web areas in the patterns can provide additional enhancements to dart impact resistance. In other words, the multilayered films with web areas without sharp corners can have an increase in puncture resistance over 53.5% compared to a similar multilayered film with web areas with sharp corners.

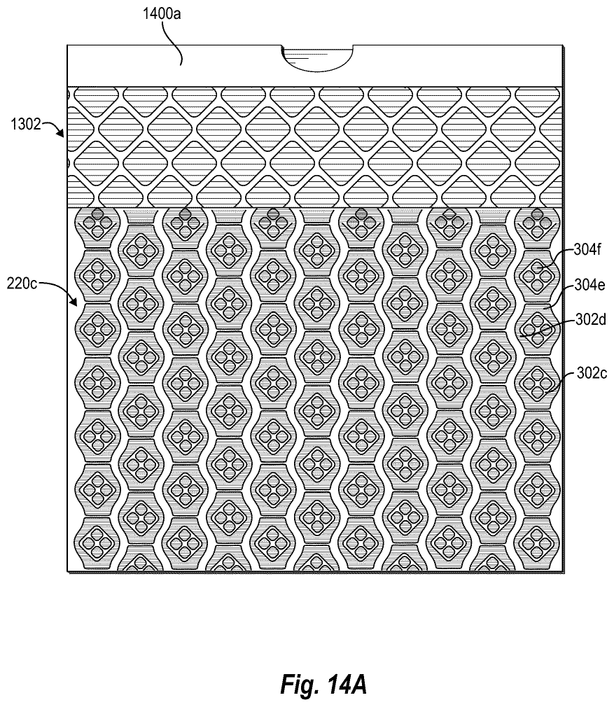

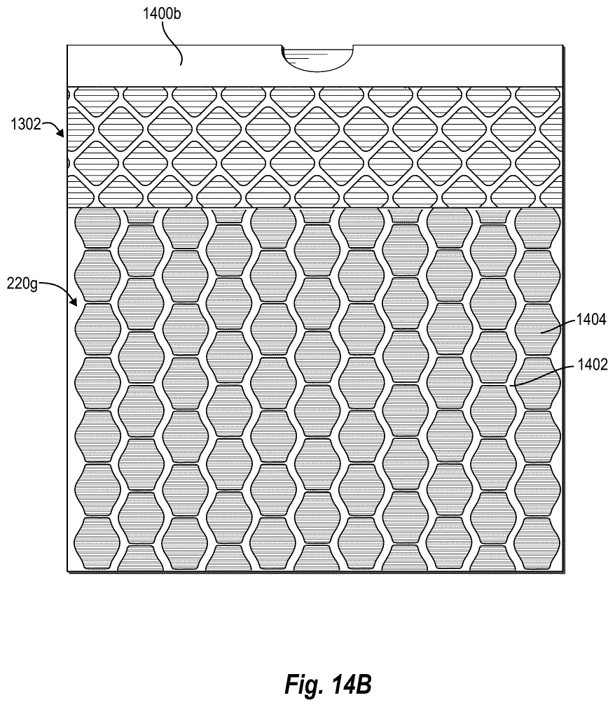

As mentioned, in one or more embodiments, a thermoplastic film has patterns of deformations separated by web areas without sharp corners. FIG. 14A illustrates a thermoplastic bag 1400a that is similar to the thermoplastic bag 1300, but with sidewalls including the pattern 220c that lacks sharp corners in the web areas. In particular, the thermoplastic bag 1400a may include a first plurality of raised rib-like elements 304e in a first motif (e.g., a macro pattern, such as a bulbous pattern) and a second plurality of raised rib-like elements 304f in a second motif (e.g., a micro pattern, such as a four-square diamond pattern). As shown, the second plurality of raised rib-like elements 304f in the second motif are interspersed with (e.g., nested within) the first motif of raised rib-like elements 304e. Furthermore, the thermoplastic bag 1400a includes web areas 302c, 302d. The web areas 302c, 302d can surround the first and second motifs of raised rib-like elements.

Moreover, the web areas 302c, 302d lack sharp corners, as the first motif and the second motif have rounded corners. As discussed, in one or more cases, the absence of sharp corners in the web areas 302c, 302d can help enhance the dart impact resistance of the thermoplastic bag 1400a. For example, by forming the raised rib-like elements such that the web areas do not have sharp corners, the possibility of stress concentrations in the thermoplastic bag can be avoided or reduced. Thus, the thermoplastic bag 1400a can have enhanced dart impact resistance over, for example, the thermoplastic bag 1300.

Additionally, FIG. 14A illustrates multiple regions of patterns in the thermoplastic bag 1400b. Similar to the thermoplastic bag 1300, the thermoplastic bag 1400a includes a first region with the pattern 220c and a second region with the fenced diamond pattern 1302 proximate the hem of the bag. In one or more cases, one region of the thermoplastic bag 1400a (e.g., the first region with the pattern 220c) has a higher dart impact resistance than another region of the thermoplastic bag 1400a (e.g., the second region with the pattern 1302).

Embodiments of the present disclosure can have different regions with different measures of dart impact resistance to provide one or more advantages. For example, by providing the first region with the pattern 220c and the second region with the pattern 1302, the thermoplastic bag 1400a can have tailored strengths based on anticipated use cases of the thermoplastic bag 1400a. For instance, it may be anticipated that a middle portion and/or a bottom portion of the thermoplastic bag 1400a will be more likely to be subjected to contact by sharp objects, whereas a top portion will be less likely to be subjected to contact by sharp objects. Thus, the patterns of deformations can be designed such that the thermoplastic bag 1400a has a relatively higher dart impact resistance in the middle and/or bottom portions than in the top portion of the thermoplastic bag 1400a.

As mentioned, designing the web areas of the patterns of deformations can enhance a thermoplastic film's dart impact resistance (e.g., separately from or in addition to utilizing multiple motifs of deformations). In one or more embodiments, the thermoplastic films and bags of the present disclosure can have a dart impact resistance between 200 grams and 350 grams. More particularly, in one or more embodiments, the thermoplastic films and bags can have a dart impact resistance between 250 grams and 300 grams. In one or more implementations, the thermoplastic films and bags can have a dart impact resistance between 280 grams and 320 grams.

FIG. 14B shows a thermoplastic bag 1400b with sidewalls including a pattern 220g of a single motif. In particular, the thermoplastic bag 1400b may include a plurality of raised rib-like elements 1404 in a first motif (e.g., a bulbous pattern). Furthermore, the thermoplastic bag 1400b includes web areas 1402 that surround the motif of raised rib-like elements 1404. As shown, the web areas 1402 do not have sharp corners, thereby helping to alleviate potential stress concentrations upon an impact by a sharp object. Thus, in one or more cases, the thermoplastic bag 1400b has enhanced dart impact resistance over similar bags (e.g., over one or more thermoplastic bags with sharp corners in the web areas).

As shown in FIG. 14B, in one or more implementations, the thermoplastic bag 1400b has web areas that include curved edges. For example, the web areas 1402 have a sinusoid or serpentine shape that has curved edges.

In one or more embodiments, a thermoplastic bag has a first region with a pattern of deformations that have web areas that lack sharp corners (such as the patterns 220c and 220g of FIGS. 14A and 14B) and a second region with a pattern of deformations that have web areas that may include one or more sharp corners. The first region with web areas that do not have sharp corners may be included in an area of the thermoplastic bag that is most likely to be subjected to sharp objects. For example, the first region may be tailored to anticipated use cases of the thermoplastic bag to help mitigate potential impacts of sharp objects.

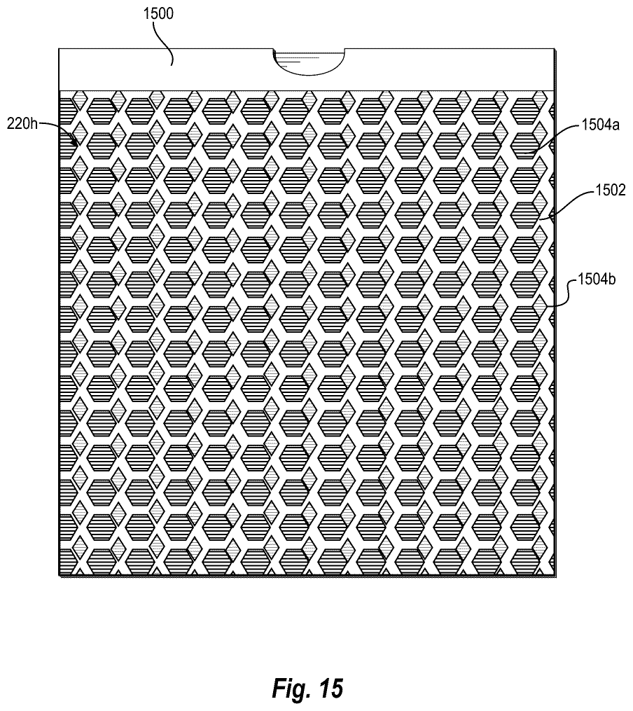

FIG. 15 illustrates a thermoplastic bag 1500 with sidewalls including a pattern 220h of deformations formed therein. In particular, the pattern 220h can comprise a first motif of raised rib-like elements 1504a in hexagon patterns, a second motif of raised rib-like elements 1504b in diamond patterns, and web areas 1502 positioned between and surrounding the hexagon and diamond patterns. As shown, the first motif of raised rib-like elements 1504a is interspersed with the second motif of raised rib-like elements 1504b within the pattern 220h.

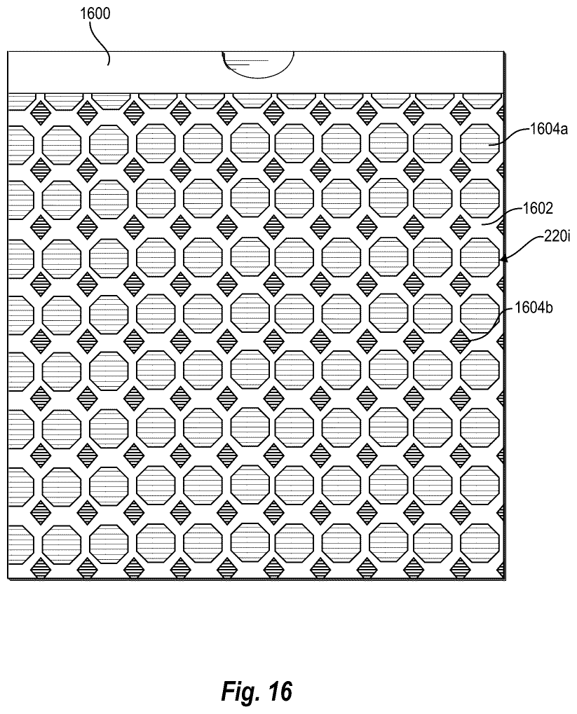

FIG. 16 illustrates a thermoplastic bag 1600 with sidewalls including a pattern 220i of deformations formed therein. In particular, the pattern 220i can comprise a first motif of raised rib-like elements 1604a in octagon patterns, a second motif of raised rib-like elements 1604b in diamond patterns, and web areas 1602 positioned between and surrounding the octagon and diamond patterns. As shown, the first motif of raised rib-like elements 1604a is interspersed with the second motif of raised rib-like elements 1604b within the pattern 220i.

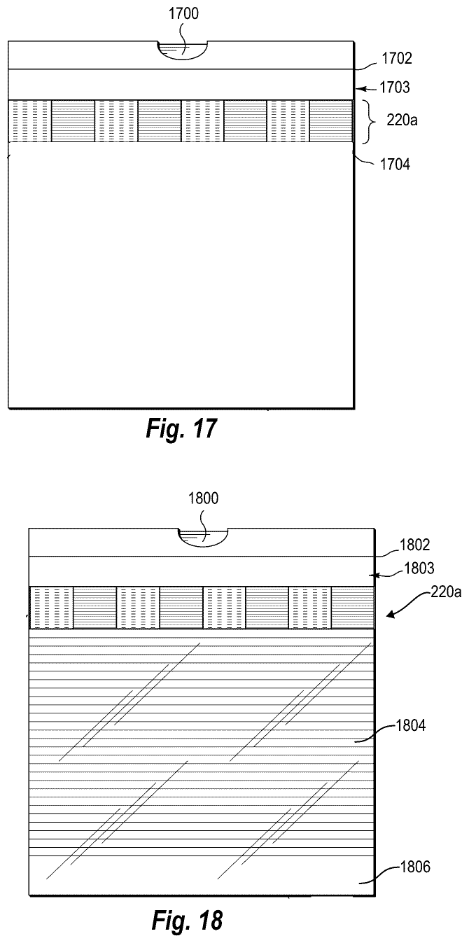

While the bags shown and described above include patterns of deformations formed in the entire sidewalls of the bags, one will appreciate in light of the disclosure herein that the present invention is not so limited. In alternative embodiments, the bags can comprise patterns of deformations in zones, regions, or areas so as to tailor the properties of different areas of the bag. For example, FIG. 17 illustrates a thermoplastic bag 1700 including a pattern of deformations 220a formed in a band proximate a hem 1702 and hem region 1703 of the bag 1700. Thus, as shown, a bottom portion 1704 of the bag 1700 (e.g., in each sidewall) is devoid of raised rib-like elements.

FIG. 18 illustrates another thermoplastic bag 1800 including a pattern of deformations 220a formed in a band proximate a hem 1802 and hem region 1803 of the bag 1800. Rather than a middle portion 1804 of the bag (e.g., in each sidewall) being devoid of raised rib-like elements, the middle portion 1804 includes incrementally stretched ribs formed by ring rolling as described in U.S. Pat. No. 9,637,278, the entire contents of which are hereby incorporated by reference. The thermoplastic bag 1800 also includes an un-stretched bottom region 1806 that is devoid of raised rib-like elements and incremental stretching.

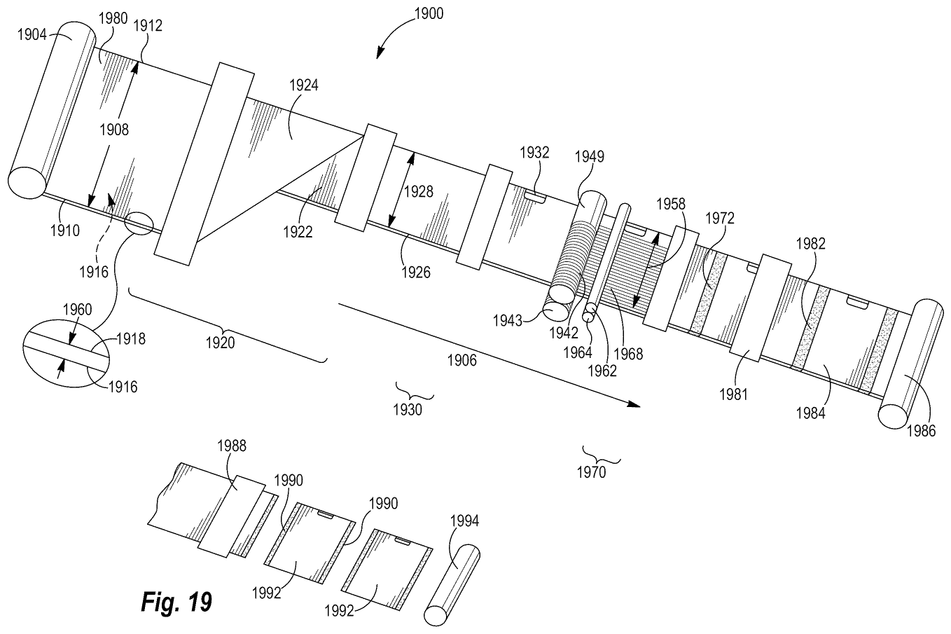

To produce a bag having a pattern or patterns of deformations as described herein, continuous webs of thermoplastic material may be processed through a high-speed manufacturing environment such as that illustrated in FIG. 19. In the illustrated process 1900, production may begin by unwinding a first continuous web or film 1980 of thermoplastic sheet material from a roll 1904 and advancing the web along a machine direction 1906. The unwound web 1980 may have a width 1908 that may be perpendicular to the machine direction 1906, as measured between a first edge 1910 and an opposite second edge 1912. The unwound web 1980 may have an initial average thickness 1960 as measured between a first surface 1916 and a second surface 1918. In other manufacturing environments, the web 1980 may be provided in other forms or even extruded directly from a thermoplastic forming process. To provide the first and second sidewalls of the finished bag, the web 1980 may be folded into a first half 1922 and an opposing second half 1924 about the machine direction 1906 by a folding operation 1920. When so folded, the first edge 1910 may be moved adjacent to the second edge 1912 of the web. Accordingly, the width of the web 1980 proceeding in the machine direction 1906 after the folding operation 1920 may be a width 1928 that may be half the initial width 1908. As may be appreciated, the portion mid-width of the unwound web 1980 may become the outer edge of the folded web. In any event, the hems may be formed along the adjacent first and second edges 1910, 1912 and a draw tape 1932 may be inserted during a hem and draw tape operation 1930.

To form a pattern 1968, the processing equipment may include SELF'ing intermeshing rollers 1942, 1943 such as those described herein above. Referring to FIG. 19, the folded web 1980 may be advanced along the machine direction 1906 between the SELF'ing intermeshing rollers 1942, 1943, which may be set into rotation in opposite rotational directions to impart the resulting pattern 1968. To facilitate patterning of the web 1980, the first roller 1942 and second roller 1943 may be forced or directed against each other by, for example, hydraulic actuators. The pressure at which the rollers are pressed together may be in a first range from 30 PSI (2.04 atm) to 100 PSI (6.8 atm), a second range from 60 PSI (4.08 atm) to 90 PSI (6.12 atm), and a third range from 75 PSI (5.10 atm) to 85 PSI (5.78 atm). In one or more implementations, the pressure may be about 80 PSI (5.44 atm).

In the illustrated implementation, the intermeshing rollers 1942, 1943 may be arranged so that they are co-extensive with or wider than the width 1928 of the folded web 1980. In one or more implementations, the intermeshing rollers 1942, 1943 may extend from proximate the folded edge 1926 to the adjacent edges 1910, 1912. To avert imparting the pattern 1968 onto the portion of the web that includes the draw tape 1932, the corresponding ends 1949 of the rollers 1942, 1943 may be smooth and without the ridges and grooves. Thus, the adjacent edges 1910, 1912 and the corresponding portion of the web proximate those edges that pass between the smooth ends 1949 of the rollers 1942, 1943 may not be imparted with the pattern 1968.

The processing equipment may include pinch rollers 1962, 1964 to accommodate the width 1958 of the web 1980. To produce the finished bag, the processing equipment may further process the folded web. For example, to form the parallel side edges of the finished bag, the web may proceed through a sealing operation 1970 in which heat seals 1972 may be formed between the folded edge 1926 and the adjacent edges 1910, 1912. The heat seals may fuse together the adjacent halves 1922, 1924 of the folded web. The heat seals 1972 may be spaced apart along the folded web and in conjunction with the folded outer edge 1926 may define individual bags. The heat seals may be made with a heating device, such as a heated knife. A perforating operation 1981 may perforate 1982 the heat seals 1972 with a perforating device, such as a perforating knife so that individual bags 1984 may be separated from the web. In one or more implementations, the webs may be folded one or more times before the folded webs may be directed through the perforating operation. The web 1980 embodying the bags 1984 may be wound into a roll 1986 for packaging and distribution. For example, the roll 1986 may be placed in a box or a bag for sale to a customer.

In one or more implementations of the process, a cutting operation 1988 may replace the perforating operation 1981. The web is directed through a cutting operation 1988 which cuts the webs at location 1990 into individual bags 1992 prior to winding onto a roll 1994 for packaging and distribution. For example, the roll 1994 may be placed in a box or bag for sale to a customer. The bags may be interleaved prior to winding into the roll 1994. In one or more implementations, the web may be folded one or more times before the folded web is cut into individual bags. In one or more implementations, the bags 1992 may be positioned in a box or bag, and not onto the roll 1994.

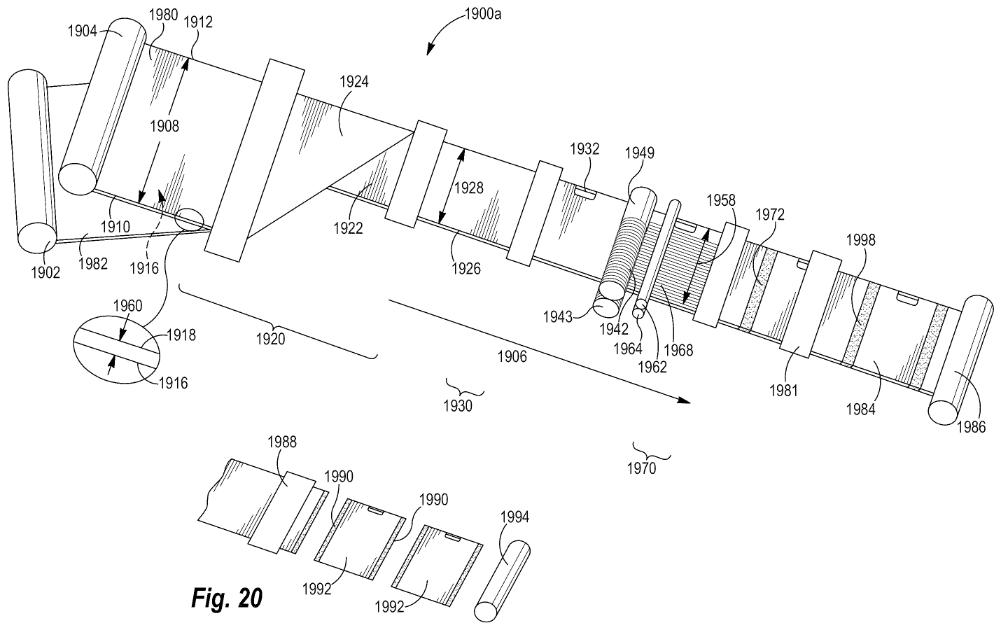

FIG. 20 illustrates a modified high-speed manufacturing process 1900a that involves unwinding a second continuous web or film 1982 of thermoplastic sheet material from a roll 1902 and advancing the web along a machine direction 1906. The second film 1982 can comprise a thermoplastic material, a width, and/or a thickness that is similar to or the same as the first film 1980. In one or more alternative implementations, one or more of the thermoplastic material, width, and/or thickness of the second film 1982 can differ from that of the first film 1980. The films 1980, 1982 can be folded together during the folding operation 1920 such that they pass through the SELF'ing intermeshing rollers 1942, 1943 together to form the pattern of deformations and resulting multi-layered bags.

The use in the foregoing description and in the appended claims of the terms “first,” “second,” “third,” etc., is not necessarily to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget, and not necessarily to connote that the second widget has two sides.

In the foregoing description, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present disclosure may be embodied in other specific forms without departing from its spirit or essential characteristics. For example, the illustrated and described implementations involve non-continuous (i.e., discontinuous or partially discontinuous) lamination to provide weak bonds. In alternative implementations, the lamination may be continuous. For example, multi film layers could be co-extruded so that the layers have a bond strength that provides for delamination prior to film failure to provide similar benefits to those described above. Thus, the described implementations are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

We claim:

1. A thermoplastic bag comprising:
a first sidewall and a second sidewall joined together along a first side edge, a second side edge, and a bottom edge;
an opening opposite the bottom edge; and
a pattern of raised rib-like elements and web areas formed in the first sidewall, wherein the pattern of raised rib-like elements and web areas comprises a first motif of deformations that repeats in the pattern and a second motif of deformations interspersed with the first motif of deformations within the pattern.

2. The thermoplastic bag of claim 1, wherein:
the first sidewall comprises a first thermoplastic film layer and a second thermoplastic film layer; and
the second sidewall comprises a third thermoplastic film layer and a fourth thermoplastic film layer.

3. The thermoplastic bag of claim 1, wherein the first sidewall has a dart impact resistance between 200 grams and 350 grams.

4. The thermoplastic bag of claim 1, wherein the first sidewall has a dart impact resistance between 250 grams and 300 grams.

5. The thermoplastic bag of claim 1, wherein the first motif of deformations comprises a first shape and the second motif of deformations comprises a second shape that differs from the first shape.

6. The thermoplastic bag of claim 1, wherein the first motif of deformations comprises a first density of raised rib-like elements and the second motif of deformations comprises a second density of raised rib-like elements that differs from the first density.

7. The thermoplastic bag of claim 1, wherein the first motif of deformations comprises a macro pattern of deformations and wherein the second motif of deformations comprises a micro pattern of deformations.

8. The thermoplastic bag of claim 1, wherein:
the pattern of raised rib-like elements and web areas is formed in a first region of the first sidewall,
an additional pattern of raised rib-like elements and web areas is formed in a second region of the first sidewall, and
the first region of the first sidewall has a higher dart impact resistance than the second region of the first sidewall.

9. A thermoplastic bag comprising:
a first sidewall and a second sidewall joined together along a first side edge, a second side edge, and a bottom edge;
an opening opposite the bottom edge;
a plurality of raised rib-like elements formed in the first sidewall; and
web areas separating repeat units of the plurality of raised rib-like elements, wherein the web areas lack sharp corners.

10. The thermoplastic bag of claim 9, wherein:
the first sidewall comprises a first thermoplastic film layer and a second thermoplastic film layer; and
the second sidewall comprises a third thermoplastic film layer and a fourth thermoplastic film layer.

11. The thermoplastic bag of claim 9, wherein the first sidewall has a dart impact resistance between 200 grams and 350 grams.

12. The thermoplastic bag of claim 9, wherein the first sidewall has a dart impact resistance between 250 grams and 300 grams.

13. The thermoplastic bag of claim 9, wherein the web areas comprise curved edges.

14. A thermoplastic bag comprising:
an outer first thermoplastic bag comprising first and second opposing sidewalls joined together along a first side edge, an opposite second side edge, an open first top edge, and a closed first bottom edge;
an inner second thermoplastic bag positioned within the outer first thermoplastic bag, the inner second thermoplastic bag comprising third and fourth opposing sidewalls joined together along a third side edge, an opposite fourth side edge, an open second top edge, and a closed second bottom edge; and
a pattern of raised rib-like elements and web areas formed in the first sidewall, wherein the pattern of raised rib-like elements and web areas comprises a first motif of deformations that repeats in the pattern and a second motif of deformations interspersed with the first motif of deformations within the pattern.

15. The thermoplastic bag of claim 14, wherein the first sidewall has a dart impact resistance between 200 grams and 350 grams.

16. The thermoplastic bag of claim 14, wherein the first sidewall has a dart impact resistance between 250 grams and 300 grams.

17. The thermoplastic bag of claim 14, wherein the web areas separate repeat units of the pattern of raised rib-like elements, and wherein the web areas lack sharp corners.

18. The thermoplastic bag of claim 14, wherein the first motif of deformations comprises SELF'ing deformations, and wherein the second motif of deformations comprises additional SELF'ing deformations.

19. The thermoplastic bag of claim 14, wherein the first motif of deformations comprises a macro pattern of deformations and wherein the second motif of deformations comprises a micro pattern of deformations.

20. The thermoplastic bag of claim 14, wherein:
the pattern of raised rib-like elements and web areas is formed in a first region of the first sidewall,
an additional pattern of raised rib-like elements and web areas is formed in a second region of the first sidewall, and
the first region of the first sidewall has a higher dart impact resistance than the second region of the first sidewall.
